(19) United States
(12) Patent Application Publication
(10) Pub. No.: US 2017/0155717 A1
(43) Pub. Date: Jun. 1, 2017

(54) DIRECT MEMORY ACCESS FOR ENDPOINT DEVICES

(71) Applicant: Intel Corporation, Santa Clara, CA (US)

(72) Inventors: Eliezer Tamir, Bait Shemesh (IL); Patrick Connor, Beaverton, OR (US)

(73) Assignee: Intel Corporation, Santa Clara, CA (US)

(21) Appl. No.: 14/953,750

(22) Filed: Nov. 30, 2015

(51) Int. Cl. H04L 29/08; H04L 12/741

(52) U.S. Cl. CPC H04L 67/1097; H04L 45/745

(57) ABSTRACT

Embodiments of the disclosure are directed to controlling an endpoint device running an endpoint device using a central control server. The central controller server is configured to communicate with the endpoint device across a communications interface compliant with a remote direct access (RDMA) compliant protocol. The central control server includes an RDMA network interface controller and a control process. The control process can execute an endpoint device algorithm to identify read and write commands to be sent across the RDMA protocol-compliant interface to the endpoint device. The RDMA network interface controller can convert messages into RDMA compliant messages that include direct read or write commands and memory location information. The endpoint device can also include a network interface controller that can understand the RDMA message, identify the memory location from the message, and execute the direct read or write access command.

### FIELD

This disclosure pertains to direct memory accesses, and more particularly, for direct memory accesses for endpoint devices.

### BACKGROUND

Communicating with remote hardware applications may include the use of network packet processing at the remote hardware. The use of additional processing of incoming and outgoing packets may result in increased resource requirements, increased latency, and cost.

Complex allocations of resources for sending and/or receiving packets are used to schedule communications between a controller and the endpoint devices. Scheduling of transactions by preallocated transmit time windows can result in complications, such as increased latency and overhead, decreased usefulness of the communications link, and requiring specialized hardware.

### BRIEF DESCRIPTION OF THE DRAWINGS

FIG. 1 is a schematic block diagram for a remote direct memory access control system in accordance with embodiments of the present disclosure.

FIG. 2 is a schematic block diagram for an apparatus for executing an endpoint device in accordance with embodiments of the present disclosure.

FIG. 3 is a process flow diagram for communicating with an endpoint device across a remote direct memory access compliant protocol in accordance with embodiments of the present disclosure.

FIG. 4 is a process flow diagram for performing direct memory accesses based on a command received across a remote direct memory access compliant protocol in accordance with embodiments of the present disclosure.

### DETAILED DESCRIPTION

Automation systems can include autonomously operating subsystems. The protocols used by some automation systems are designed for serial communications. TCP/IP connections and Ethernet is used by others. To maintain serial protocol compatibility, the Ethernet media uses time domain multiplexing to mimic the legacy serial protocol. Using Ethernet reduces latency, but automation protocols often do not take full advantage of the features that Ethernet provides.

This disclosure describes a central control server that monitors and controls one or more endpoint devices, such as those in a workflow for an automation system. The central control server uses the RDMA protocol to directly read and/or write endpoint device operational parameters, e.g., via memory mapped control registers of the endpoint device state machine. This allows for low latency real time control over the managed system. Examples of endpoint devices include automatum, robot, machine, process flow, industrial process, mechanical device, power system, etc.

Instead of each endpoint device being controlled by a micro-controller or network processor local to the endpoint, this disclosure describes moving control to a central control server. By moving control to a central control server, end-to-end workflow analysis and optimization can be realized. Endpoint devices would no longer be limited to data within their immediate subsystem. Endpoint device subsystems can be repurposed as needed because specific control functionality for applications is moved to the central control server, while endpoint devices retain functionality to implement direct read or write access to execute commands received from the central control server. For example, assembly robots can automatically change extensions to perform different tasks, which can reduce idle time.

Additionally, the endpoint devices no longer need a micro-controller or network processor. Instead, an endpoint controller interface in communication with the endpoint device can include an RDMA network interface controller (RNIC) can be used to parse commands received from the central control server across the RDMA interface. Moreover, a network interface controller with reduced complexity can further reduce the costs and latency for receiving and executing commands (e.g., an rNIC with a lower case “r” is introduced). This less complex rNIC can further reduce the unit cost and points of failure while maintaining functionality to parse RDMA messages.

An additional advantage of the present disclosure is end-to-end safety. Instead of the subsystems operating independently, in which case the subsystems have a limited ability to detect or adapt to other systems, the present disclosure improves the overall system safety by centralizing control of the entire line. Interactions can be determined before commands are issued by, e.g., confirming machine addresses in RDMA messages received from the central control server. Additionally, instead of each endpoint device holding its own state information, the central control server can hold the state information for each endpoint device, and therefore, for the entire system. Changes to the state of an endpoint device can compromise safety; by having the central control server monitor the state information for each endpoint device and responding to errant states or changes to states, the central control server can address issues, shut down endpoint devices, or shut down the entire workflow. The central control server would also be able to alert emergency responders, other workflows of upstream issues, and track valuable metrics. Further, state information can be updated quickly and often without burdening the communications interface or the central control server processing.

This disclosure can utilize auto-configuration of the endpoint and controller utilizing an XML file to exchange capabilities. These can include sensor types, number of axis, range of motion, extension limits, attachment types, security protocols supported, power levels, belt rates, and other parameters (e.g., endpoint device parameters, etc.).

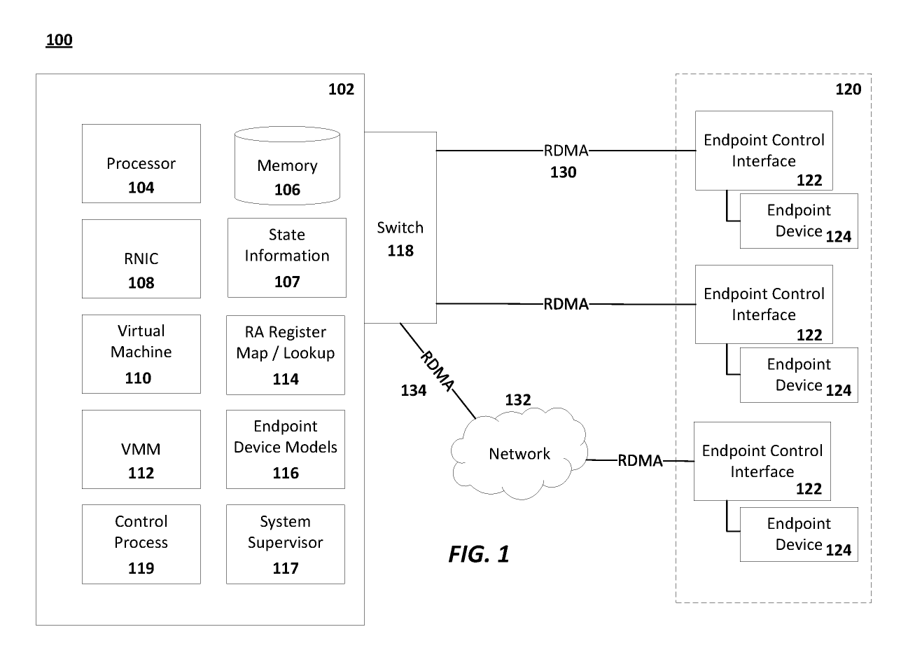

FIG. 1 is a schematic block diagram for a remote direct memory access (RDMA) control system 100 in accordance with embodiments of the present disclosure. RDMA control system 100 includes a central control server 102 in communication with one or more endpoint control interfaces 122 across an RDMA protocol compliant communications interface 130 (in short, an RDMA interface 130). In some embodiments, each endpoint control interface 122 can be part of a process workflow 120 (e.g., an industrial workflow or manufacturing plant). In some embodiments, each endpoint control interface 122 can be autonomous from each other and/or part of different workflows. Each endpoint control interface 122 can be connected to, integrated into, or otherwise in communication with an endpoint device 124. Endpoint device 124 can be an automatum, robot, machine, process flow, industrial process, mechanical device, power system, etc. Endpoint device 124 can be implemented at least partially in hardware. Each endpoint device 124 can be the same or can be different.

The central control server 102 can execute a control process 119 that models the processes of the endpoint device 124, or can simulate the endpoint device 124. The processor 104 can execute the control process 119 using state information 107 and endpoint device models 116. In some embodiments, the control process can include one or more endpoint device models 116 that model the control processes for each process or procedure or action associated with an endpoint device. Endpoint device models 116 can include a local or internal model of each endpoint device 124. The endpoint device models 116 can include each process or procedure that the endpoint device 124 would perform to derive a next state of the endpoint device 124. Endpoint device models 116 can make use of state information 107 received from the endpoint control interface 122 across the RDMA interface 130 and/or state information 107 stored in memory 106.

Processor 104 can be implemented at least partially in hardware, and can include software and firmware. The processor 104 can include any processor or processing device, such as a microprocessor, an embedded processor, a digital signal processor (DSP), a network processor, a handheld processor, an application processor, a co-processor, a system on a chip (SOC), or other device to execute code.

The control process 119 uses the endpoint device model 116 and state information 107 to identify a next action or next state for the endpoint device 124, essentially running the model at the central control server 102 to mimic the processes or procedures of the endpoint device 124. To achieve the next desired state, a command may be needed to be sent to the endpoint device, indicating what needs to change in order to achieve it. The next state information can correspond to a read or write command, which can include a read length and memory location or a write length, value, and memory location. The RNIC 108 can convert the command into a message compliant with the RDMA protocol. The message can include, among other things, a machine address for the endpoint device and a steering tag. The steering tag represents a memory region for the read/write command at the endpoint device. The steering tag can include a steering tag offset value to specify the memory location for the read/write command. The steering tag offset may be associated with a control register in the endpoint device state machine. The message can also include the command and a value.

In some embodiments, the central control server 102 includes a virtual machine 110. In some implementations, the control process 119 can reside in the virtual machine 110 or be implemented by the virtual machine 110. While only one virtual machine is shown, central control server 102 may include more virtual machines than those illustrated. Virtual machine 110 may make use of hardware resources, including processor 104 and memory 106. Hardware resources may be virtualized, meaning that a single physical hardware resource may be partitioned into multiple virtual hardware resources to enable system 100 to use the single physical hardware resource in multiple virtual machine 110. Virtualization may be implemented using virtual machine monitor (VVM) 112. In an embodiment, VMM 112 includes software that imposes a virtualization layer in central control server 102 in which hardware resources may be virtualized into a virtual machine 110. The virtual machine 110 can make use of state information 107 and endpoint device models 116 to, e.g., determine a next state for the endpoint device 124.

The virtual machine 110 can execute endpoint device models 116 to execute operations associated with the endpoint device 122. The virtual machine 110 can use state information received from the endpoint control interface 122 across the RDMA interface 130 to execute algorithms, thereby moving processing of algorithms from the endpoint control interface 122 to the central control server 102. The virtual machine 110 can execute commands to alter the state of the endpoint control interface 122. This state information is communicated across the RDMA interface 130 in an RDMA message that includes a write command, a memory location indicator (e.g., a steering tag), and other information, such as a machine address and connection address. Essentially, the virtual machine 110 can perform processing for the endpoint device 124; the RNIC 108 and the RDMA interface 130 allow for low latency communications between the central control server 102 and the endpoint control interface 122 so that the virtual machine 110 can read the state of the endpoint device 124, process that information, and send write information to the endpoint control interface 122 with low latency.

The memory 106 may include memory location information 114 about one or more endpoint devices 124 to which the central control server 102 is connected. The memory 106 can include memory location information 114 for each of the one or more endpoint devices 124. The memory information can include a steering tag value mapped to a memory location. For example, the memory location information 114 can include a steering tag value that maps to a memory location in endpoint device 124. The memory location at the endpoint device 124 can be associated with a function of the endpoint device 124.

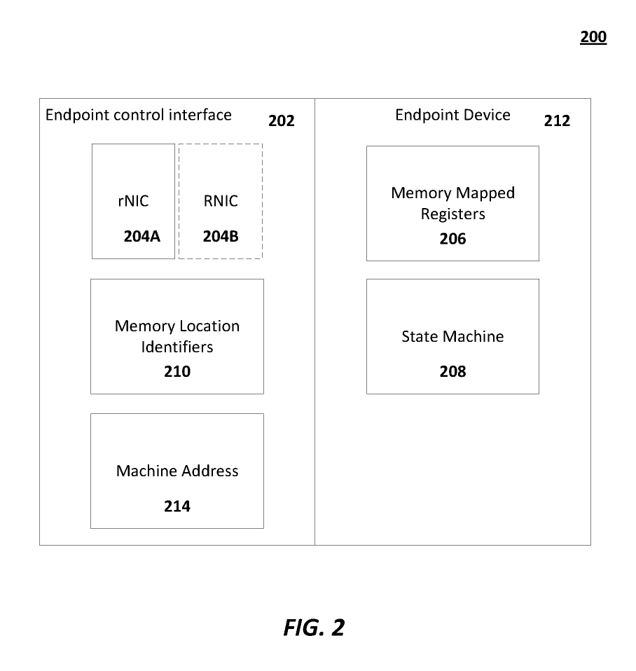

The memory 106 can also store a lookup table. After the control process 119 determines the next state for the endpoint device 124, the lookup table can be used by the RNIC 108 to figure out which memory mapped register(s) (in FIG. 2, memory mapped register 206) at the endpoint device 124 need to be accessed to execute the next stage, and what are the endpoint machine address, steering tag, and steering tag offset for accessing the register(s).

RDMA network interface controller (RNIC) 108 can be used to encapsulate information from the control process 119 or virtual machine 110 into an RDMA message that is compliant with the RDMA protocol. RDMA facilitates direct memory access to memory on a remote system (e.g., endpoint device 108) in a manner that bypasses the system CPU and operating system of the receiving device. The bypassing of CPU and operating system means that RDMA messaging can be low latency. RDMA supports zero-copy networking by enabling an RNIC to transfer data directly to or from application memory (i.e., a memory space in system memory allocated to an application) that is maintained separate from kernel memory used by an operating system, eliminating the need to copy data between application memory and data buffers in kernel memory employed by the operating system.

The central control server 102 can use a mechanism for allocating memory called Memory Registration. Memory registration facilitates access to a Memory Region by the RNIC 108. Binding a Memory Window allows the RNIC 108 to access memory represented by that Memory Window. Memory registration provides mechanisms that allow the RNIC 108 to access a memory mapped register at the endpoint device 124 using a Steering Tag (STag) and a Tagged Offset. Memory registration provides the RNIC 108 with a mapping between a STag and a memory location at the endpoint device 124. The memory registration also provides the RNIC 108 with a description of the access control associated with the memory location 114. The set of memory locations that have been registered are referred to as a Memory Region. Before an RNIC 108 can use a Memory Region, the resources associated with the Memory Region and the Memory Region itself can be registered with the RNIC 108.

There are local STags which represent registered memory on this system, and there are remote STags, which the system on the other side of the connections has registered memory to. The remote memory is abstract in the sense that the local side is not aware of its exact location

As mentioned previously, the message transmitted by the RNIC 108 to the endpoint control interface 122 is a message that is compliant with an RDMA protocol. The message includes memory information, such as a steering tag (or sTag), as well as a machine address for the destination endpoint device and data that represents a read or write operation. In some embodiments, the message may also include a connection address so the endpoint device can verify that the source of the message is a known connection and not an intruder.

Central control server 102 can also include a system supervisor 117 implemented at least in hardware to supervise each of the endpoint devices 124. The system supervisor 117 can monitor state information for each of the endpoint device 124. Based on the state information, the system supervisor 117 can identifier errant states for each endpoint device. The system supervisor 117 can shut down the endpoint device 124 if an errant state is detected. The system supervisor 117 can also shut down a whole workflow 120 if warranted (e.g., by the identification of an errant state of one or more endpoint devices 124).

System 100 also includes a switch 118. Switch 118 can be an integrated switch in the central control server. An integrated switch can include a multi-host Ethernet controller silicon with integrated Ethernet switching resources. An example of an integrated switch includes RED ROCK CANYON™. Since the traffic is primarily top-down, the congestion is minimal and flow control is minimal. A free-standing switch can also be used in some implementations.

FIG. 2 is a schematic block diagram 200 for an endpoint control interface 202 for controlling an endpoint device 212 in accordance with embodiments of the present disclosure. The endpoint control interface 202 may be implemented at least in hardware. Endpoint control interface 202 may be integrated into or otherwise in communication with an endpoint device 212. Endpoint device 212 can be an automatum, robot, machine, or other component of an automated or remotely controlled/monitored process architecture. Endpoint control interface 202 may include logic that includes a network interface controller 204 and a memory mapped register 206. The memory mapped register 206 includes register addresses corresponding to pins on the endpoint device 212 and allow for direct access to the endpoint device 212 through the memory mapped register 206.

The network interface controller (NIC) in FIG. 2 may be a full RDMA NIC (RNIC) 204B or may be a modified version of an RNIC (referred to as rNIC 204A, labeled with a lowercase “r” to denote a simplified or limited implementation of the RNIC or RDMA protocol).

The rNIC 204A implements a subset of the full RDMA protocols. For example, the rNIC 204A can support a single connection or several connections to a central control server, as opposed to supporting thousands or millions of connections. Instead of building a large table or lookup mechanism, the rNIC 204A can perform a direct comparison of received addressing and memory location values in parallel (e.g., by hardcoding the values within the rNIC 204A). In some instances, the rNIC 204A can be specifically tailored to the endpoint device 212, and the machine address values and memory locations can be hardcoded to the rNIC 204A.

The rNIC 204A can be configured to handle 3 types of messages: a write command, a read command, and a read response. Additionally, the rNIC 204A can forgo retransmit operations, such as TCP/IP retransmit protocols. The central control server 102 can be configured to send additional read requests if prior read requests go unanswered within a predetermined amount of time (microseconds, milliseconds, seconds, minutes, etc.).

The rNIC 204A is configured to receive an RDMA message that includes a direct access command, such as a read or write, and includes a memory location identifier. The memory location can be a steering tag value that maps to a memory location in the memory mapped register 206. For an rNIC 204A, the RDMA message can include a reduced number of steering tag values as compared to an RDMA message for an RNIC 204B. For example, the rNIC 204A is configured to communicate with a single peer or at most a several peers.

In some embodiments, the endpoint control interface 202 can include memory location information 210, which can be a library or table of information or a hardcoded set of information. In some embodiments, the memory location information 210 can include specific memory locations to allow the rNIC 204A to translate steering tag offset values into memory locations in the memory mapped register 206.

The endpoint control interface 202 can also include machine identifiers 214. The endpoint control interface 202 can compare machine identifiers in the message received from the central control server 102 with the machine identifier 214 of the endpoint device to confirm that the message is intended for the endpoint control interface 202.

In some embodiments, the RNIC 204B would include an interface to a table of values for connection addresses and memory addresses. The rNIC 204A does not need to include the interface to a table of values because there is less information in the received RDMA message, and the rNIC 204A can compare the information in the RDMA message against one or two values. Further, the rNIC 204A can transmit read responses back to the RNIC in the central control server. The rNIC 204A may not need to retransmit messages (including partial messages). Rather, the central control server can resend read requests after the expiration of a predetermined time. Additionally, the rNIC 204A generally does not initiate a connection with the central control server 102. Rather, the rNIC 204A accepts messages from the central control processor and can respond to read requests, using an existing connection established by the central control server 102.

Because the endpoint device functionality is simulated on the central control server, short (e.g., up to one maximum transmission unit) RDMA messages using only a handful of RDMA STags can be used to read or write map register contents. This allows the endpoint control interface 202 to only implement a fraction of the RDMA and TCP functionality while maintaining low latency read and write operations. The rNIC 204A can connect to a fully implemented RNIC on the central control server, thereby reducing the hardware requirement from the rNIC 204A.

The memory location information 210 can point to memory locations in the memory mapped register 206. Memory locations may represent access points to the endpoint device 212 for directly accessing command functions. A read from the memory location can indicate a present state of the endpoint control interface 202 (or more specifically, a state of a function of the endpoint control interface 202 from a state machine 208). A write to a memory location can cause the endpoint device to change its state in the state machine 208 or perform a function.

The rNIC 204A can receive a message from across a communications interface compliant with an RDMA protocol. The message may include a steering tag (sTag) that represents window or region of the memory mapped register 206. The sTag also includes an sTag offset value that represents a specific portion of the window or region of the memory mapped register 206 to be accessed. For example, the sTag can indicate a window of memory registers, say registers 1-10, and the offset can represent register 1+x, where x is the offset from 1.

The memory mapped register 206 can include silicon logic that directly interfaces with the endpoint device 212. An rNIC 204A reads or writes to the memory mapped register 206. The endpoint device 212 control is based on the values at each register of the memory mapped register 206. For example, the rNIC 204A can write to the memory mapped register to cause the endpoint device 212 to change its state. Similarly, state information of the endpoint device 212 can be read from a memory mapped register location.

The endpoint device 212 can also include a state machine 208. The state machine 208 can include silicon logic. The state machine 208 can interface with the endpoint device 212. In state machine 208, every value has an address. The rNIC 204A can write or read to the state machine 208 by memory mapped registers 206.

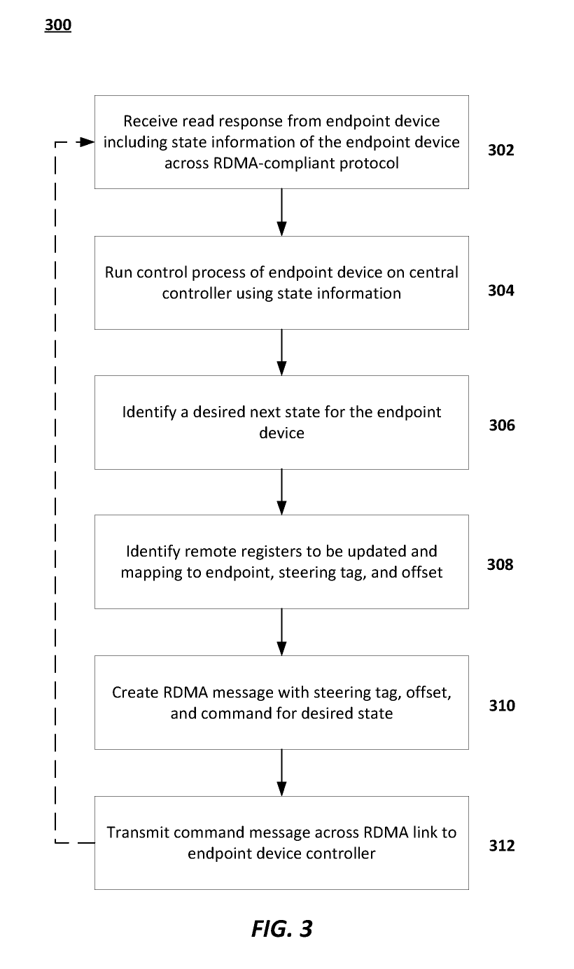

FIG. 3 is a process flow diagram 300 for communicating with an endpoint device across a remote direct memory access compliant protocol in accordance with embodiments of the present disclosure. A central control server can receive from across a communications interface compliant with a remote direct memory access (RDMA) protocol an RDMA message containing state information for an endpoint device from an endpoint control interface (302). The central control server can receive the RDMA message via an RDMA network interface controller (RNIC). The central control server can run a control process or virtual machine representing the endpoint device using the state information received from across the RDMA communications interface (304). The output of the control process or virtual machine can include an identification of a desired state of the endpoint device (306) For example, the result may include a command to change the state of the endpoint device (e.g., a write command) or a command to provide further state information (e.g., a read command).

The central control server can identify a memory location for the read or write command (308). The memory location can be identified based on a memory information library, which can include one or more steering tag values mapped to memory locations in a memory mapped register at the endpoint device controlling the endpoint device. Additionally, the central control server can identify a machine address identifier and a connection identifier for the endpoint device.

The central control server, via the RNIC, can encapsulate the command and the memory location information into a message, such as an RDMA message (310). The RNIC can transmit the RDMA message to the endpoint device across a communications interface compliant with the RDMA protocol (312). In some embodiments, the central control server can, via the RNIC, receive a read response from the endpoint device, which is indicated as the dotted arrow returning to (302).

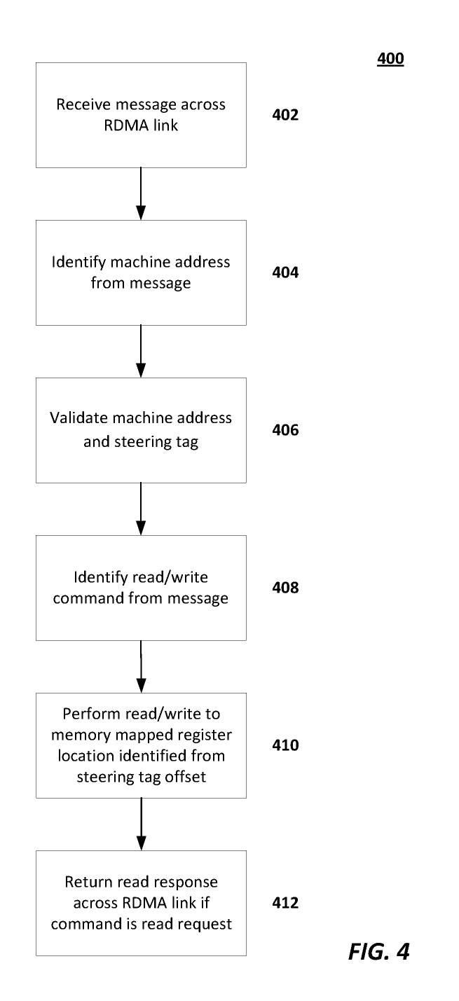

FIG. 4 is a process flow diagram 400 for performing direct memory accesses based on a command received across a remote direct memory access (RDMA) compliant protocol in accordance with embodiments of the present disclosure. An RDMA-compliant network interface controller (rNIC) on an endpoint device can receive an RDMA message (402) from a central control server from across an RDMA compliant communications interface. The rNIC can identify a machine address from the RDMA message (404) to confirm that the message is meant for the endpoint device. In some implementations, the rNIC includes a filter that can filter out packets that do not have MAC addresses configured for the receiving rNIC. The rNIC can identify a command from the RDMA message (406). For example, the command can be a read command or a write command. The rNIC can identify a memory location for the command (408). The rNIC can be hardcoded with a memory location mapping to a memory mapped register. The memory location can be identified by a memory location identifier, such as a steering tag value. The rNIC can directly access the memory mapped register based on the memory location from the message (410). The access can be a write operation, in which the rNIC directly writes to a location in the memory mapped register. The access can be a read operation, in which the rNIC reads from a location in the memory mapped register. The rNIC can send a read response to the central control server across the RDMA compliant communications interface (412).

This disclosure allows for multiple security options to be used:

1. A key embedded in the device VNM, scanned via QR code at installation time to load other side onto the server (public/private key).

2. One time initial handshake with the endpoint connected to the server directly.

3. MACSeC/LinkSec

4. IPSec

This disclosure also includes the ability to have the equipment halt or return to a safe position (depending on the machine type) if/when network connectivity is lost. This can be implemented with a simple periodic heart beat packet, detection of link loss or other mechanism.

The systems and apparatuses described herein can reduce the computation power needed on the equipment side by an order of magnitude making it extremely simple. This is important because industrial components are designed with durability as one of the topmost priorities; they need withstand vibration, heat, and other harsh environments with minimal maintenance for their service life.

The present disclosure may also apply to Internet of Things (IOT) devices. As shown in FIG. 1, the central control processor 102 can transmit RDMA messages (or messages that conform at least in part to the RDMA protocol). The messages can be transmitted across a wireless network (e.g., a cellular network or WIFI network or other wireless technology). The network interface controller on the endpoint device can receive the messages from across a wireless network.

This disclosure describes the use of RDMA protocols. Among the various RDMA protocols contemplated by this disclosure are internet Wide Area RDMA Protocol (iWARP), RDMA over Converged Ethernet (RoCE), and INFINIBAND™.

It should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this specification.

In example 1, aspects of the embodiments are directed to a control server that includes a central processor implemented at least in hardware to execute a control process representing an endpoint device to identify a memory location for direct memory access for the endpoint device and a network interface controller implemented at least in hardware to communicate a message across a communications interface compliant with a remote direct memory access (RDMA) protocol with an endpoint executing the endpoint device, the message comprising the memory location for direct memory access of the endpoint.

In example 2, the subject matter of example 1 further includes that the processor identifies a steering tag value for the direct memory access for the endpoint device based on executing the control process, and wherein the memory location comprises a steering tag value.

In example 3, the subject matter of examples 1 or 2 may include an integrated switch connecting the network interface controller with the endpoint.

In example 4, the subject matter of examples 1 or 2 or 3 may include that the central processor identifies a routing address of the endpoint based on executing the control process and the integrated switch routes the message to the endpoint based on the routing address.

In example 5, the subject matter of any of examples 1 or 2 or 3 or 4 may also include that the network interface controller comprises an RDMA controller to configure an RDMA message for transmission to the endpoint, the RDMA message comprising a direct memory access command and the memory location.

In example 6, the subject matter of any of examples 1 or 2 or 3 or 4 or 5 may also include a steering tag library that includes steering tag values that correspond to memory locations of the endpoint, and wherein the processor executes a control process corresponding to the end point endpoint device to identify a steering tag that corresponds to a memory location for a direct memory access of the endpoint.

In example 7, aspects of the embodiments are directed to receiving, at a central control server, state information for an endpoint device of an endpoint device from across a communications interface compliant with a remote direct memory access (RDMA) protocol; executing, at the central server, a simulation of the endpoint device based on the state information; identifying a memory location for direct memory access of the endpoint device based on the simulation of the endpoint device; constructing an RDMA message that includes the memory location and a direct memory access command; and transmitting the RDMA message to the endpoint device across a communications interface compliant with an RDMA protocol.

In example 8, the subject matter of example 7 can also include identifying, based on the simulation, a steering tag value that corresponds to the memory location of the endpoint device for the direct memory access command.

In example 9, the subject matter of any of examples 7 or 8 can also include identifying a machine address for the endpoint device and wherein constructing the RDMA message comprises adding the machine address to the endpoint device to the RDMA message.

In example 10, the subject matter of example 7 can also include receiving, from the endpoint device across the communications interface compliant with the RDMA protocol, a read response from the endpoint device.

In example 11, aspects of the embodiments are directed to computer program product tangibly embodied on non-transitory computer readable media, the computer program product including instructions that when executed are operable to execute, at a central server, a simulation of an endpoint device of an endpoint device; identify a memory location for direct memory access of the endpoint device based on the simulation of the endpoint device; construct a remote direct memory access (RDMA) message that includes the memory location and a direct memory access command; and transmit the RDMA message to the endpoint device across a communications interface compliant with an RDMA protocol.

In example 12, the subject matter of example 11 can also include instructions further operable to identify, based on the simulation, a steering tag value that corresponds to the memory location of the endpoint device for the direct memory access command.

In example 13, the subject matter of example 11 or 12 can also include instructions further operable to identify a machine address for the endpoint device and wherein constructing the RDMA message comprises adding the machine address to the endpoint device to the RDMA message.

In example 14, the subject matter of example 11 can also include instructions further operable to receive, from the endpoint device across the communications interface compliant with the RDMA protocol, a read response from the endpoint device.

In example 15, aspects of the embodiments are directed to an endpoint device in communication with a central control server across a communications interface compliant with a remote direct memory access (RDMA) protocol. The endpoint device can include a memory mapped register and a network interface controller implemented at least in hardware. The network interface controller can be configured to receive an RDMA message from the central control server across the communications interface; identify a memory location in the memory mapped register for direct memory access from the RDMA message; identify a command for the direct memory access from the RDMA message; and directly access the memory location to satisfy the command.

In example 16, the subject matter of example 15 may include that the RDMA message identifies a memory location in the memory mapped register, and wherein the network interface controller is configured to directly access the memory location in the memory mapped register.

In example 17, the subject matter of example 15 or 16 may include that the memory location of the message includes a steering tag value that corresponds to a memory location in the memory of the endpoint device.

In example 18, the subject matter of example 15 or 16 or 17 may include that the network interface controller includes a hardwired steering tag value, and the network interface controller is configured to identify the memory location in the memory based on comparing the memory location in the message with a hardwired steering tag value.

In example 19, the subject matter of example 15 or 16 or 17 or 18 may include that the network interface controller includes at least a portion of an RDMA controller.

In example 20, aspects of the embodiments are directed to a method performed in an endpoint device. The method may include receiving, by a network interface controller, a message from across a communications interface compliant with a remote direct memory access (RDMA) compliant protocol; identifying, by the network interface controller, a memory location from the message for a direct memory access; identifying, by the network interface controller, a command from the message; and executing, by the network interface controller, the direct memory access based on the command from the message.

In example 21, the subject matter of example 20 can also include that the message includes a steering tag value that identifies a memory location of a memory of the endpoint device.

In example 22, the subject matter of example 20 can also include comparing, by the network interface controller, the steering tag value in the message with a steering tag value at the endpoint device, the steering tag value at the endpoint device corresponding to a memory location of the memory at the endpoint device.

In example 23, the subject matter of example 20 can also include identifying a machine address from the message and confirming the machine address from the message matches a machine address of the endpoint device.

In example 24, aspects of the embodiments are directed to a computer program product tangibly embodied on non-transitory computer readable media, the computer program product including instructions that when executed are operable to receive a message from across a communications interface compliant with a remote direct memory access (RDMA) compliant protocol; identify a memory location from the message for a direct memory access; identify a command from the message; and execute the direct memory access based on the command from the message.

In example 25, the subject matter of example 24 can also include that the message comprises a steering tag value that identifies a memory location of a memory of the endpoint device.

In example 26, the subject matter of example 24 can also include instructions further operable to compare the steering tag value in the message with a steering tag value at the endpoint device, the steering tag value at the endpoint device corresponding to a memory location of the memory at the endpoint device.

In example 27, aspects of the embodiments are directed to an endpoint device in communication with a central control server across a communications interface compliant with a remote direct memory access (RDMA) protocol. The endpoint device can include a memory mapped register means and a network interface controller means implemented at least in hardware. The network interface controller means can be configured to receive an RDMA message from the central control server across the communications interface; identify a memory location in the memory mapped register means for direct memory access from the RDMA message; identify a command for the direct memory access from the RDMA message; and directly access the memory location to satisfy the command.

In example 28, aspects of the embodiments are directed to an endpoint device in communication with a central control server across a communications interface compliant with a remote direct memory access (RDMA) protocol. The endpoint device can include a memory mapped register and a network interface controller implemented at least in hardware. The network interface controller can be configured to receive an RDMA message from the central control server across the communications interface; identify a memory location in the memory mapped register for direct memory access from the RDMA message; identify a command for the direct memory access from the RDMA message; and directly access the memory location to satisfy the command. In some embodiments, the endpoint device does not include a micro-controller or a network processor, but rather includes a rNIC or RNIC for parsing messages sent by the central control server over the RDMA protocol.

In example 29, aspects of the embodiments are directed to a system that includes a central control server that includes a central processor implemented at least in hardware to execute a control process representing an endpoint device to identify a memory location for direct memory access for the endpoint device and a network interface controller implemented at least in hardware to communicate a message across a communications interface compliant with a remote direct memory access (RDMA) protocol with an endpoint executing the endpoint device, the message comprising the memory location for direct memory access of the endpoint. The system also includes one or more endpoint devices. Each endpoint device can include a memory mapped register and a network interface controller implemented at least in hardware. The network interface controller can be configured to receive an RDMA message from the central control server across the communications interface; identify a memory location in the memory mapped register for direct memory access from the RDMA message; identify a command for the direct memory access from the RDMA message; and directly access the memory location to satisfy the command. The endpoint device does not include a micro-controller or a network processor, but rather includes a rNIC or RNIC for parsing messages sent by the central control server over the RDMA protocol.

Example 30 may include the subject matter of example 29, wherein the endpoint device lacks one or both of a microcontroller or a network processor.

Example 31 may include the subject matter of example 29 or 30, wherein network interface controller comprises an RDMA controller to configure an RDMA message for transmission to the endpoint device, the RDMA message comprising a direct memory access command and the memory location.

Example 32 may include the subject matter of any of examples 29 or 30 or 931, wherein the network interface controller comprises a hardwired memory register address, and the network interface controller is configured to identify the memory register address in the memory based on comparing the memory register address with a steering tag offset value.

Example 33 may include the subject matter of any of examples 29 or 30 or 31 or 32, wherein the network interface controller comprises an RDMA network interface controller.

Example 34 may include the subject matter of any of examples 29 or 30 or 31 or 32 or 33, wherein the endpoint device does not include a micro-controller or a network processor, but rather includes a rNIC or RNIC for parsing messages sent by the central control server over the RDMA protocol.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A control server apparatus comprising:
a processor implemented at least in hardware to execute a control process representing an endpoint device to identify a next action for the endpoint device;
a network interface controller implemented at least in hardware to communicate a message across a communications interface compliant with a remote direct memory access (RDMA) protocol with an endpoint device, the message comprising a steering tag, a steering tag offset, and a command for direct memory access of the endpoint.

2. The control server apparatus of claim 1, wherein the processor identifies a steering tag value for the direct memory access for the endpoint device based on executing a control process for the endpoint device, and wherein the memory location comprises a steering tag offset value.

3. The control server apparatus of claim 1, further comprising an integrated switch connecting the network interface controller with the endpoint.

4. The control server apparatus of claim 3, wherein the processor identifies a MAC address of the endpoint device based on executing the control process and the integrated switch routes the message to the endpoint device based on the MAC address.

5. The control server apparatus of claim 1, wherein network interface controller comprises an RDMA controller to configure an RDMA message for transmission to the endpoint device, the RDMA message comprising a direct memory access command and the memory location.

6. The control server apparatus of claim 1, further comprising a steering tag table that includes steering tag values that correspond to memory locations of the endpoint device, and wherein the processor executes a control process corresponding to the endpoint device to identify a steering tag that corresponds to a memory location for a direct memory access of the endpoint device.

7. A computer program product tangibly embodied on non-transitory computer readable media, the computer program product including instructions that when executed are operable to:
execute, at a central server, a control process of an endpoint device;
identify a memory location for direct memory access of the endpoint device based on the control process of the endpoint device;
construct a remote direct memory access (RDMA) message that includes the memory location and a direct memory access command; and
transmit the RDMA message to the endpoint device across a communications interface compliant with an RDMA protocol.

8. The computer program product of claim 7, the instructions further operable to identify, based on the control process, a steering tag value that corresponds to the memory location of the endpoint device for the direct memory access command.

9. The computer program product of claim 7, the instructions further operable to identify a machine address for the endpoint device and wherein constructing the RDMA message comprises adding the machine address to the endpoint device to the RDMA message.

10. The computer program product of claim 7, the instructions further operable to receive, from the endpoint device across the communications interface compliant with the RDMA protocol, a read response from the endpoint device.

11. The computer program product of claim 7, wherein transmit the RDMA message to the endpoint device across a communications interface compliant with an RDMA protocol comprises transmitting the RDMA message to an endpoint control interface associated with the endpoint device.

12. An endpoint device in communication with a central control server across a communications interface compliant with a remote direct memory access (RDMA) protocol, the endpoint device comprising:
a memory mapped register; and
a network interface controller implemented at least in hardware to:
receive an RDMA message from the central control server across the communications interface;
identify a memory location in the memory mapped register for direct memory access from the RDMA message;
identify a command for the direct memory access from the RDMA message; and
directly access the memory location to satisfy the command.

13. The endpoint device of claim 12, wherein the RDMA message identifies a memory location in the memory mapped register, and wherein the network interface controller is configured to directly access the memory location in the memory mapped register.

14. The endpoint device of claim 12, wherein the memory location of the message comprises a steering tag offset value that corresponds to a memory location in the memory of the endpoint device.

15. The endpoint device of claim 12, wherein the network interface controller comprises a hardwired memory register address, and the network interface controller is configured to:
identify the memory register address in the memory based on comparing the memory register address with a steering tag offset value.

16. The endpoint device of claim 12, wherein the network interface controller comprises an RDMA network interface controller.

17. The endpoint device of claim 12, wherein the endpoint device lacks one or both of a microcontroller or a network processor.

18. A computer program product tangibly embodied on non-transitory computer readable media, the computer program product including instructions that when executed are operable to:
receive a message from across a communications interface compliant with a remote direct memory access (RDMA) compliant protocol;
identify a memory location from the message for a direct memory access;
identify a command from the message; and
execute the direct memory access based on the command from the message.

19. The computer program product of claim 18, wherein the message comprises a steering tag offset value that identifies a memory location of a memory of the endpoint device.

20. The computer program product of claim 19, the instructions further operable to compare the steering tag value in the message with a steering tag value at the endpoint device, the steering tag value at the endpoint device corresponding to a memory location of the memory at the endpoint device.
